(19) United States
(12) Patent Application Publication
(10) Pub. No.: US 2026/0188880 A1
(43) Pub. Date: Jul. 2, 2026

(54) TUNING ELEMENT MODULE FOR A MODULAR WAVEGUIDE JUNCTION

(71) Applicant: Nokia Solutions (Shanghai) Co., Ltd., Shanghai (CN)

(72) Inventors: Denis TUAU, Trignac (FR); Gildas BENGLOAN, Nantes (FR)

(73) Assignee: Nokia Solutions (Shanghai) Co., Ltd., Shanghai (CN)

(21) Appl. No.: 19/131,669

(22) PCT Filed: Nov. 22, 2022
(86) PCT No.: PCT/CN2022/133559

§ 371 Date: May 21, 2025

(51) Int. Cl. H01P 1/165; H01P 5/12; H01Q 13/00

(52) U.S. Cl. CPC H01P 1/165; H01P 5/12; H01Q 13/00

(57) ABSTRACT

A tuning element module (100) for a modular waveguide junction (200) for combining and/or separating first and second signals (301,302) of differing polarizations, wherein the tuning element module (100) is configured to removably attach to said modular waveguide junction (200).

### TECHNOLOGICAL FIELD

Examples of the present disclosure relate to waveguide components, in particular a tuning element module for a modular waveguide junction for combining and/or separating first and second signals of differing polarizations. Some examples, though without prejudice to the foregoing, relate to a turnstile junction, for use in an orthomode transducer, wherein the turnstile junction has a removable turnstile.

### BACKGROUND

Conventional waveguide junctions for combining and/or separating first and second signals of differing polarizations (e.g. such as turnstile junctions), for use in an orthomode transducer, are not always optimal.

Turnstile junctions comprising a turnstile element, e.g. a metallic protrusion such as a pin, disposed centrally within the turnstile junction are known. However, typically such a turnstile element of a turnstile junction is integrally formed with the turnstile junction. Moreover, such a turnstile element is typically machined/milled as part of the machining/milling of the turnstile junction. Accordingly, conventional turnstile elements typically have a basic shape—as it is difficult to machine/mill the turnstile junction so as to have complexity/high precision shapes of the turnstile element—and are unable to finely control the performance of the conventional turnstile junction.

In some circumstances it can be desirable to enhance and/or tune the performance of a turnstile junction. In some circumstances it can be desirable to modify the performance of a turnstile junction (e.g. selective performance modification such as to tune the turnstile junction to favour one polarization state over another, or favour certain frequency bands/sub-bands over another). In some circumstances it can be desirable increase the design flexibility of a turnstile junction. In some circumstances it can be desirable simplify the manufacture/machining of a turnstile junction (and hence reduce production costs).

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided a tuning element module for a modular waveguide junction for combining and/or separating first and second signals of differing polarizations, wherein the tuning element module is configured to removably attach to said modular waveguide junction.

According to at least some examples of the disclosure there is provided a modular waveguide junction for combining and/or separating first and second signals of differing polarization, wherein the modular waveguide junction is configured to receive a removable tuning element module. The modular waveguide junction may further comprise the removable tuning element module.

According to at least some examples of the disclosure there is provided an orthomode transducer comprising the modular waveguide junction.

According to at least some examples of the disclosure there is provided an antenna system comprising:
the orthomode transducer;
an antenna configured to transmit and/or receive a combination of the first and second signals; and optionally at least on diplexer.

According to various, but not necessarily all, examples of the disclosure there is provided a method of providing, assembling and/or manufacturing an apparatus and/or system as described herein.

According to various, but not necessarily all, examples of the disclosure there is provided a method of using an apparatus and/or system as described herein.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples, the modular waveguide junction comprises one or more selected from the group of:
a turnstile junction;
an orthomode junction; and
a junction of an orthomode transducer.

In some but not necessarily all examples, the tuning element module comprises a turnstile for use in a turnstile junction.

In some but not necessarily all examples, the tuning element module comprises means for adjusting one or more of:
a radio frequency performance of said modular waveguide junction;
an operational bandwidth of said modular waveguide junction;
an operational frequency of said modular waveguide junction;
a return loss characteristic of said modular waveguide junction.

In some but not necessarily all examples, the tuning element module comprises an elongate member extending from a base member.

In some but not necessarily all examples, the elongate member comprises one or more of:
at least one tuning stub; and
at least one metallic pin.

In some but not necessarily all examples, a cross-sectional shape of the elongate member varies along its length.

In some but not necessarily all examples, the elongate member comprises one or more of:
at least one cylindrical portion, and
at least one rectangular portion.

In some but not necessarily all examples, the elongate member comprises a rectangular portion with rounded edges.

In some but not necessarily all examples, the elongate member comprises a cylindrical portion with a plurality of protruding rounded edges projecting therefrom.

In some but not necessarily all examples, a cross-sectional dimension of the elongate member varies along its length.

In some but not necessarily all examples, the tuning element module further comprises means for providing a radio frequency wave trap.

In some but not necessarily all examples, the tuning element module further comprises at least one notch around a perimeter of the base member.

In some but not necessarily all examples, the tuning element module further comprises means for facilitating insertion into said modular waveguide junction.

In some but not necessarily all examples, the base member comprises a chamfered edge or a bevelled edge.

In some but not necessarily all examples, the tuning element module further comprises means for locating and/or aligning the tuning element module in said modular waveguide junction.

In some but not necessarily all examples, the base member comprises at least one projecting boss member.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIG. 3 shows another example of the subject matter described herein;

FIG. 4 shows another example of the subject matter described herein;

FIG. 5 shows another example of the subject matter described herein;

FIG. 6 shows another example of the subject matter described herein;

FIG. 7 shows another example of the subject matter described herein;

FIG. 8 shows another example of the subject matter described herein;

FIG. 9 shows another example of the subject matter described herein;

FIG. 10 shows another example of the subject matter described herein;

FIGS. 11a-11g show another example of the subject matter described herein;

FIGS. 12a and 12b show another example of the subject matter described herein;

FIG. 13 shows another example of the subject matter described herein;

FIGS. 14a and 14b show another example of the subject matter described herein;

FIG. 15a-15d shows another example of the subject matter described herein; and

FIG. 16 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### DETAILED DESCRIPTION

The figures schematically illustrate, and the following description describes, various examples of the disclosure including a tuning element module 100 for a modular waveguide junction 200 for combining and/or separating first 301 and second 302 signals of differing polarizations, wherein the tuning element module is configured to removably attach to the modular waveguide junction.

FIG. 1 schematically illustrates a tuning element 100 of a waveguide junction 200, wherein the tuning element is removable from the waveguide junction (as indicated by the dotted arrow and the dotted outline of the tuning element module 100′when attached to the waveguide junction).

The waveguide junction is configured for combining and/or separating a first signal 301 and second signal (not shown in FIG. 1) having differing polarizations.

In some examples, the differing polarizations are orthogonal polarizations such as a vertical polarization, V-polar, and a horizontal polarization, H-polar.

In some examples, the waveguide junction is a junction, such as a turnstile junction, of an orthogonal mode transducer (also known as an orthomode transducer or OMT), configured to allow, in a first (e.g. reception) mode of operation, orthogonal separation of two orthogonally polarized signals received via a dual-polarized antenna of a dual dual-polarized antenna system. In a second (e.g. transmission) mode of operation, the waveguide junction is configured to allow orthogonal combination of two orthogonally polarized signals for transmission via the dual-polarized antenna. In other words, the OMT is a waveguide-component capable of dividing an orthogonally polarized electro-magnetic signal (e.g. with circular polarization TE11) into two linearly polarized signals (e.g. with linear polarization TE10); and, in a reverse direction, it is capable of combining two linearly polarized signals into an orthogonally polarized electro-magnetic signal (e.g. with circular polarization TE11). In such a manner, the OMT may serve as a polarisation duplexer.

FIG. 1 schematically illustrates a cross sectional cut-through of the waveguide junction in the x-y plane wherein a transmission mode of the first signal 301 (comprising signal component 301₁ of the first signal which is input via port 201₁ of the waveguide junction, and signal component 301₂ of the first signal which is in phase opposition [i.e. 180° phase difference] to the first signal component and which is input via port 201₂ of the waveguide junction) is transformed to a signal 303 having different transmission mode and which is output via port 203 of the waveguide junction.

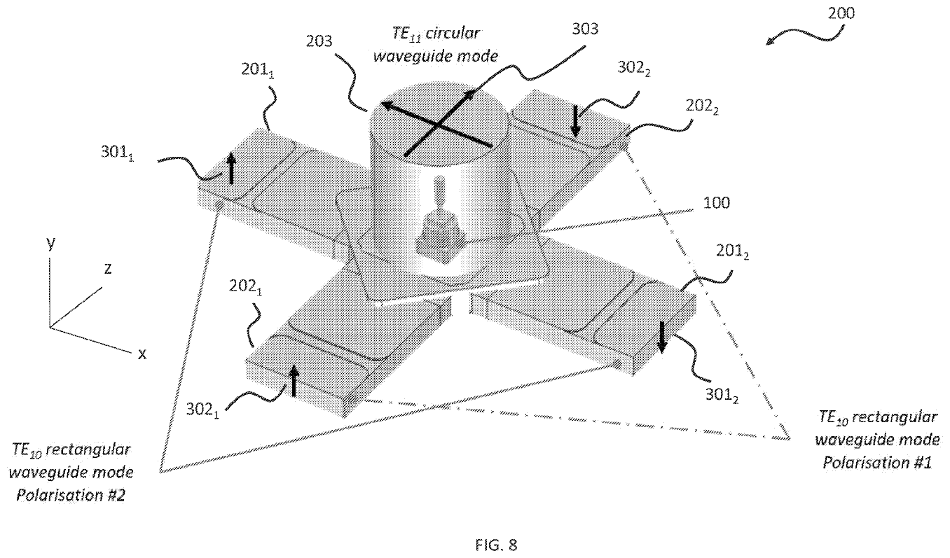

An arrangement analogous to that shown in FIG. 1 would also be provided in the y-z plane (this is more clearly illustrated in the example of a waveguide junction 200 shown in FIG. 8), wherein, a transmission mode of a second signal 302 (comprising signal component 302₁ input via port 202₁ of the waveguide junction, and signal component 302₂ input via port 202₂ of the waveguide junction) is transformed to a signal 303 having different transmission mode and output via port 203 of the waveguide junction.

In some examples, the waveguide junction is a Radio Frequency, RF, structure that is configured to transform/combine the first and second signals, each propagating (e.g. along rectangular waveguides) in TE₁₀ modes, into a signal propagating (e.g. along a circular or rectangular waveguide) in a TE₁₁ mode. The waveguide junction is likewise configured to transform/separate a signal propagating in a TE₁₁ mode into first and second signals propagating in TE₁₀ modes. In some examples, the first and second signals are transformed/combined into a signal propagating along a square waveguide supporting a TE10 mode and an orthogonally set TE01 mode.

In some examples the signals are RF electromagnetic waves. In some examples, the first and second signals are in a 6 GHz band and a 8 GHz band respectively (the 6 GHz frequency band being defined from 5.925 GHz to 7.125 GHz, and the 8 GHz being defined from 7.4 GHz to 8.5 GHz). In such a manner, the first and second signals provide broadband bandwidth to cover from 5.925 GHz to 8.5 GHz.

The removably attachable/insertable tuning element enables the waveguide junction to be modulable, i.e. the removably attachable tuning element serves as a tuning element module of a modular waveguide junction.

In some examples, the modular waveguide junction is a modular turnstile junction, and the tuning element module is a removable/detachable turnstile module of the modular turnstile junction.

Conventional turnstile junctions (N.B. that are not modular nor do they have a removable/detachable turnstile module) are RF structures that allow a recombination of two signals having orthogonal polarizations. For each polarization signal, a recombination of two rectangular access signals, in phase opposition, in TE10 mode is carried out which generates a signal into a circular waveguide in TE11 mode. In other words, a turnstile junction is a polarization discriminator. When operating in a reception mode of operation (e.g. receiving an input signal, comprising signal components having orthogonal polarizations, in TE11 mode at an input for of the turnstile), each linear polarization component of the input signal is directed to a pair of output ports that are perpendicular to/aligned with the input port. Conventional turnstile junctions may comprise one or more metallic pins, often merely a simple metallic pin, at the centre of the conventional turnstile junction to improve impedance matching and also to align and rotate the signals to provide an optimum signal TE11 mode. However, in conventional turnstile junctions, such metallic pins are integral/fixed/permanently attached to the turnstile junction and not removable/detachable.

Examples of a modular turnstile junction, with a removable/detachable turnstile module in accordance with the present disclosure may be somewhat similar in functionality to a conventional turnstile junction, albeit with the significant difference that in examples of the present disclosure, the turnstile module is removable/detachable.

In the following description, the term ‘tuning element module’ can be interchangeably referred to as a turnstile module a removable turnstile. In the following description, the term modular waveguide junction′ can be interchangeably referred to as a modular turnstile junction and a turnstile junction with a removable turnstile.

In some examples, the tuning element module is configured to enable a tuning, i.e. modification/adjustment of the performance, of the waveguide junction. In some examples, the tuning element module comprise means configured to adjust one or more of:
a radio frequency performance of said modular waveguide junction;
an operational bandwidth of said modular waveguide junction;
an operational frequency of said modular waveguide junction;
a return loss characteristic of said modular waveguide junction (for example, to favour certain frequencies/sub-bands over others, and/or favour one polarization over another).

An operational bandwidth (operational resonant mode) is a frequency range over which an RF component, such as the waveguide junction, can efficiently operate. An operational bandwidth may be defined as where a return loss of the component is greater than an operational threshold T such as, for example, 3 or 4 dB.

Advantageously, the provision of a detachable tuning element module allows the tuning element module to be machined separately from the rest of the modular waveguide junction. Hence the tuning element module (and the shape and dimensions of its metallic pins) can be customized and machined to a complex shape/set of shapes with high precision; whereas the rest of the modular waveguide junction can be machined to a lesser degree of precision. Hence the manufacturing of the waveguide junction can be simplified.

Moreover, advantageously the provision of a removable tuning element module allows one tuning element module of a modular waveguide junction to be interchangeable/replaceable with another tuning element module. This enables the modular waveguide junction, and indeed an antenna assembly comprising the same (such as an arrangement comprising an orthomode transducer, having such a modular waveguide junction, and an antenna coupled to the same) to be tuned to modify its RF performance characteristics so as to be optimised for a desired application by replacing one tuning element module with another tuning element module that is optimised for the desired application. By contrast, in conventional (non-modular) waveguide junctions having a tuning element, the tuning element is integrally formed/permanently fixedly attached to the waveguide junction. Hence, tuning elements in conventional (non-modular) waveguide junctions are not detachable and interchangeable/replaceable. Hence, conventional waveguide junctions are not able to be selectively tuned/have their RF performance modified as per examples of the tuning element modules and modular waveguide junctions of the present disclosure (instead modifying the RF performance of a conventional waveguide junction would require a total rework and modification of the entire waveguide junction structure).

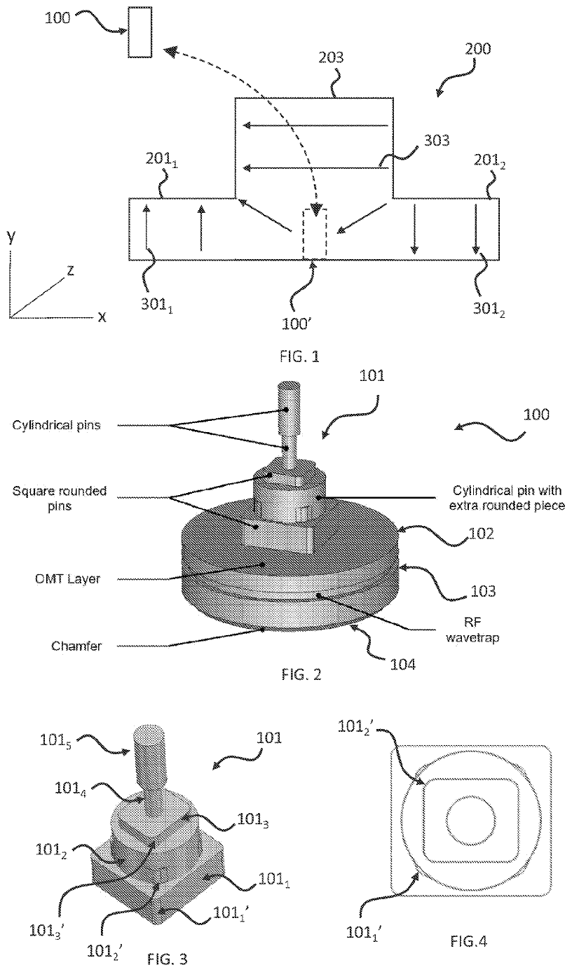

FIG. 2 shows another example of a tuning element module 100.

The tuning element module comprises an elongate member 101 extending from a circular base member 102 of the tuning element module. The base member of the tuning element module is configured for inserted into a correspondingly shaped hole in the modular waveguide junction (as shown with respect to hole 204 in the modular waveguide junction of FIGS. 4 and 5). The base and hole are configured such that, when the base is inserted in the hole, an upper surface of the base member is coplanar/flush with a surface of the modular waveguide junction (such a surface corresponding to an inner lower surface of the modular waveguide junction, for example, where the modular waveguide junction is used in an OMT, the surface may correspond to an OMT layer).

In some examples, the cross-sectional shape and cross-sectional dimension (i.e. width or diameter) of the elongate member varies along its length.

In some examples, the elongate member takes the form of one or more conductive/metallic pins and/or one or more tuning/matching stubs. In some examples, such one or more pins or tuning/matching stubs may take the form of a stack of multiple conductive/metallic pins of differing shapes, wherein each pin may have a substantially cylindrical, cuboid or rectangular cuboid shape. In some examples, such one or more pins/tuning stubs may take the form of one or more conductive/metallic portions having a substantially circular, square or rectangular cross-section of differing sizes. In some examples, the tuning element module 101 and/or certain components thereof (such as the pins/tuning stubs 101ₙ) are at least partially non-metallic (i.e. they are not all metal). In some examples, the tuning element module 101 and/or certain components thereof (such as the pins/tuning stubs 101ₙ) are made of a hybrid material, for example a combination of a plastic material and metal, or a plastic material with a metallic coating.

The modular waveguide junction's conversion of TE10 modes to a TE11 mode over a wide frequency band can be enhanced/achieved by using a tuning element module having cylindrical and cubic shaped central pins to improve the RL and bandwidth. In particular, the tuning element can be configured to allow the RL of a sub-band or polarisation to be specifically controlled by changing the dimensions of the central pins. The tuning element module brings flexibility to the design of a modular waveguide junction and OMT comprising the same, and avoids the need to redesign an entire radio path or the whole OMT to improve device performance.

The tuning element module is designed to be detachable and interchangeable, providing flexibility in the design of the modular waveguide junction and OMT comprising the same, hence reducing redesign costs. As an OMT structure without the tuning element module may be broadband, the modular waveguide junction and OMT can be modified at will to tune the performances over the wide band of operation by changing just the detachable and replaceable tuning element module. The tuning element module can be configured in the shape and dimension of its metallic pins so as to favour the RL of one polarisation over another (RL disymmetrisation), or to favour the RL on particular sub-bands.

A turnstile junction is part requiring very high machining precision, especially for the metallic pins. It involves a thorough milling process to respect the accuracy needed. However, radio paths which are on the same layer generally do not require a milling process as precise as for the turnstile junction. Hence, a classic OMT turnstile junction requires high machining cost.

The invention proposes to design and produce a separate turnstile junction, which represents a key point for improving the current OMT production. This reduces the cost of machining the layers containing the radio channels and speeds up the process of making the turnstile junction separately. In addition, a higher level of quality and accuracy is achieved by making this part separately.

The tuning element module comprises means 103 for providing a radio frequency wave trap. In some examples, such means comprises the provision of at least one gap/notch 103 around a perimeter of the base member, such as a groove/indentation surrounding circumferential side wall. As will be appreciated from FIG. 7, when the tuning element module is inserted into the modular waveguide junction, the gap remains between the tuning element module and the modular waveguide junction, which thereby serves as an RF wave trap which may ensure that leakage currents do not interfere with the operation of the waveguide junction. The shape and size of the gap/RF wave trap can be configured and optimized in order to limit the current leakage as much as possible which may arise due to play between the tuning element module and the modular waveguide junction.

The tuning element comprises means 104 for facilitating insertion of the base member into the modular waveguide junction. In some examples, such means comprises a chamfered or bevelled edge 104 for facilitating insertion of the base member into a hole of the modular waveguide junction.

FIGS. 3 and 4 show a perspective view and a plan view respectively of the elongate member 101 of the tuning element module 100 of FIG. 2.

The elongate member comprises plurality of conductive/metallic pins/tuning stubs of differing sizes and shapes 101₁-101₅.

In some examples, the cylindrical pins are provided at a distal/top end of the of the elongate member and cubic pins are provided at a proximal/bottom end of the elongate member proximal to the base member (not shown).

In the example shown, the elongate member comprises a stacked arrangement of differing pins 101ₙ all coaxially/concentrically aligned, namely:
a cuboid/rectangular cuboid/rectangular prism shaped pin 101₁, with rounded edges 101₁′, that projects upwardly from the base member (not shown);
a cylindrical pin 101₂, with 4 equally spaced rounded edges 101₂′ projecting laterally from the sidewall of the cylindrical pin, such projecting rounded edges being aligned with the rounded edges of the square pin;
a further cuboid/rectangular cuboid/rectangular prism shaped pin 101₃, with rounded edges 101₃′;
a further cylindrical pin 101₄; and
a yet further cylindrical 101₅, of differing diameter to the other cylindrical pins.

The elongate member, with its multiple metallic pins 101ₙ of differing shapes and sizes, are configured to gradually transform two polarised signals from a circular TE11 mode (or a square TE10 and orthogonally set TE01 mode) to rectangular TE10 modes (and vice versa). This avoids an abrupt transition from one mode to the other, thus ensuring high bandwidth and good RL. The total height of the metallic pins may be substantially λ/2 and the width of the square lowermost pin may be substantially λ/4.

In some examples, the elongate member, and its multiple metallic pins of differing shapes and sizes, are configured to gradually transform/divide two polarised signals from a square TE10 and orthogonally set TE01 mode into two signals with 180° phase difference.

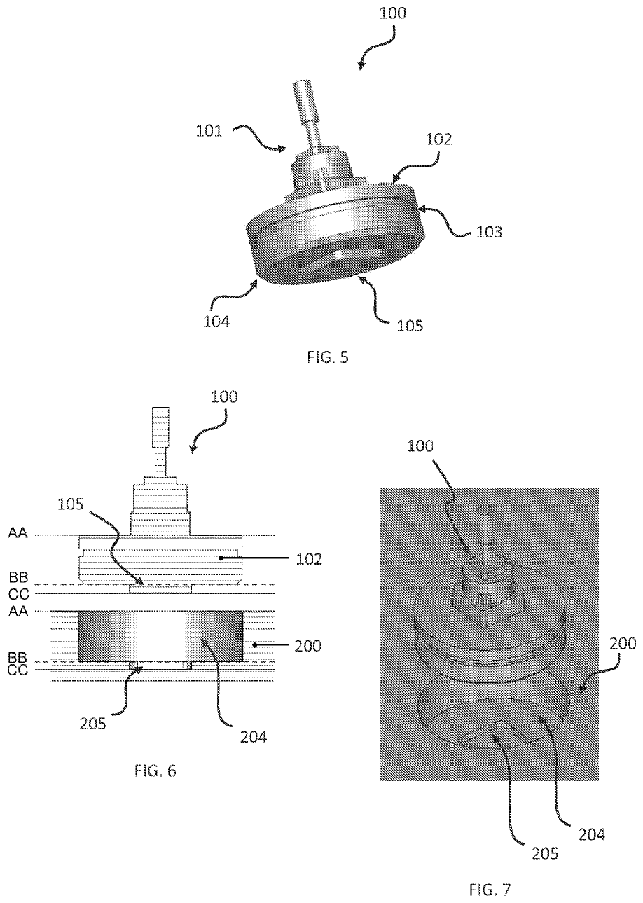

FIG. 5 illustrates a perspective view of the tuning element module 100 of FIG. 2, and shows an underside of the base member 102. The underside of the base member 102 comprises means 105 for locating and/or aligning the tuning element module in a hole of the modular waveguide junction (as discussed below with respect to FIGS. 6 and 7). In some examples, such means comprises at least one projecting boss member 105. In the example shown, such means comprises a square base/protrusion that is configured to fit into one of the layers of the turnstile junction. This square base serves as a mechanical coding to ensure that the orientation of the turnstile module with respect to the modular turnstile junction is correct, and that the cuboid metallic pins are appropriately in line with the radio channels/rectangular waveguides exiting the turnstile junction.

FIGS. 6 and 7 show a side on cross-sectional view of the tuning element module 100 and a part of the modular waveguide junction 200 into which the tuning element module is to be inserted into. These figures show the hole 204 and recess 205 of the modular waveguide junction that are correspondingly shaped and aligned to respectively receive the base member 102 and boss 105 of the tuning element module 100. When the tuning element module 100 is inserted and duly attached to the modular waveguide junction, the plane line AA of the tuning element module is co-planer with the plane line AA of the modular waveguide junction. Once inserted into the modular waveguide junction, the detachable turnstile then perfectly level with the modular waveguide junction layer. The illustrates planes AA, BB and CC of the tuning element module and the modular waveguide junction are merged when the tuning element module is fully inserted into the modular waveguide junction.

FIG. 8 schematically shows an example of a modular waveguide junction 200 having a tuning element module 100 inserted therein. The modular waveguide junction (and its tuning element module) is configured to transform signals from TE10 mode to TE11 mode.

In this example the modular waveguide junction is a turnstile junction 200 (configured to allow two TE10 mode polarisations to be combined orthogonally), and the tuning element module is a removable turnstile 100 of the turnstile junction.

The turnstile junction comprises a central circular waveguide/arm/port 203 perpendicular to a co-planer arrangement of two pairs of rectangular waveguides/arms/ports 201₁, 201₂, 202₁, 202₂. The first pair of rectangular waveguides/ports 201₁ 201₂ are co-axially aligned. The second pair of rectangular waveguides/ports 202₁, 202₂ are co-axially aligned. The first pair of rectangular waveguides/ports are aligned orthogonally to the second pair of rectangular waveguides/ports (and both the first and second pairs of waveguides/ports are perpendicular to the central circular waveguide/port 203 which extends/upwardly projects from the central crossing/intersection point of the four rectangular waveguides/ports.

The turnstile is removable insertable into the central crossing/intersection point of the four rectangular waveguides/ports. In order to maximize the bandwidth of the turnstile junction, the turnstile may comprise a stack of plural metallic pins of differing shapes and dimensions that transition in shape from square to circular (e.g. not least for example: square>square with rounded edges>circular with protruding rounded edges>circular cross-sectional shapes).

Each of the four rectangular waveguides is configured to support/propagate signals in a TE10 mode of transmission. The circular waveguide (or backfire feed link) is configured to support/propagate signals in a TE11 mode of transmission.

The turnstile junction uses one pair of two TE10 waveguides per polarisation (e.g. vertical polarization (V-polar) and horizontal polarization (H-polar)), thereby forming a set of four orthogonal rectangular waveguides that support the two polarisations and which recombine at their crossing and exit in an orthogonal direction via the circular waveguide/port 203. In this regard, a first signal 301 (comprising signal component 301₁ input via port 201₁, and signal component 301₂ input via port 201₂) propagates in a TE10 mode of transmission. A second signal 302 (comprising signal component 302₁ input via port 202₁, and signal component 302₂ input via port 202₂) propagates in a TE10 mode of transmission. The first and second signals are transformed to a signal 303 having a TE11 mode of transmission which is output via port 203.

In some examples, the rectangular waveguides of the turnstile junction are rounded rectangular waveguides. This may provide more smoothness in the wave path and may improve both the return loss, RL, and the bandwidth of the turnstile junction. The metallic pins consist of multiple cylinders and rounded cubic blocks optimised to improve the transition between the circular and rectangular modes, and to improve polarisation separation.

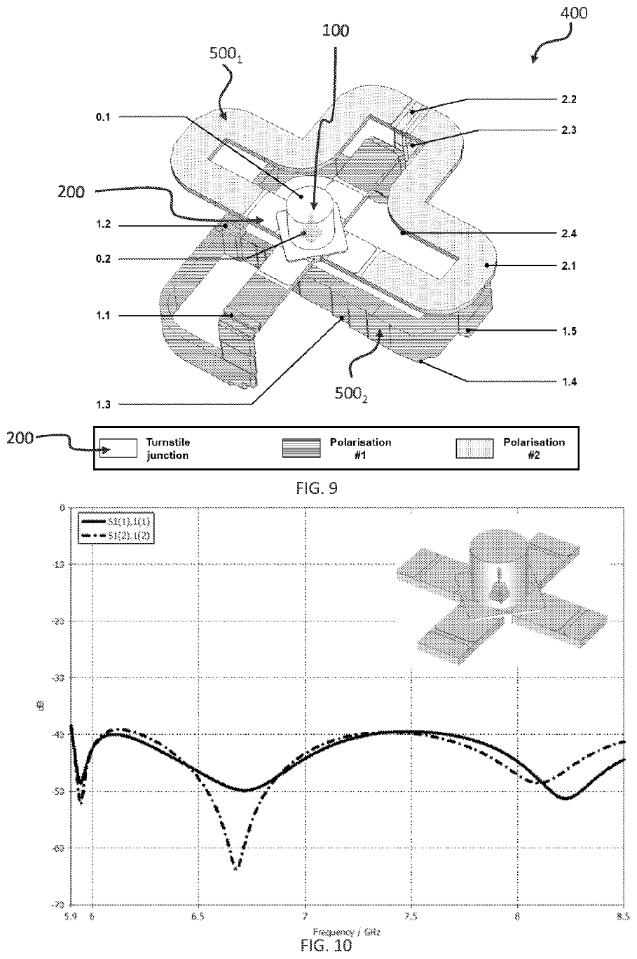

FIG. 9 shows an OMT 400 comprising: a module turnstile junction 200, a turnstile module 100, and radio paths 500₁ and 500₂, one for each polarization #1 and #2.

The radio paths comprise straight and elbows optimized to minimize an overall footprint of the OMT. A T-junction is used per polarization to recombine the first and second signals. Stepped impedance waveguides are also used to adjust the dimensions of the output waveguides to a common port defined to support two operating frequency sub-bands.

The main elements of the OMT shown in FIG. 7 correspond to the following blocks:
0.1—Circular waveguide (e.g. 203 of FIG. 8) of the turnstile junction. This section is connected to a feed of an antenna (not shown).
0.2—Metallic pins (e.g. 101 of FIG. 2) of the turnstile junction. These are a part of the removable section of the turnstile junction, i.e. the removable turnstile module 100. The metallic pins (i.e. their shape and dimensions) are configured to tune the OMT performances.
1.1—E-plane right-angle rectangular waveguide
1.2—E-plane wideband T-junction
1.3—Stepped impedance waveguide
1.4—Spline-based optimized right angle waveguide
1.5—Common port waveguide of polarization #1
2.1—Spline-based optimized right angle waveguide
2.2—E-plane wideband T-junction
2.3—Stepped impedance waveguide ended by common port waveguide of polarization #2

The dimensions of the metallic pins 101ₙ, play management, the shape of the mechanical coding/boss 105, the location of the gap/RF wave trap 103 are parameters of the turnstile module 100 that modify the operation of the modular turnstile junction (i.e. when the turnstile module is inserted therein) and hence modify the operation of the OMT. Therefore, the performance of the turnstile junction (and an OMT comprising the same) can be adjusted via the configuration of the turnstile module. A specific frequency sub-band of operation can be tuned taking into account the dimensions of the metallic pins, the play and wave trap parameters. Consequently, no modification of radio paths of the OMT is required. Furthermore, the shape of the metallic pins can be changed in order to modify the RL of each polarisation. In nominal use, a square shape is used as to balance RL of each polarisation, but asymmetric shape such as rectangular may be employed. This allows different RL values for each polarisation to be obtained.

It is to be appreciated that the turnstile module of a modular OMT can be removably attached to the modular OMT during production of the modular OMT. In addition or alternatively, the turnstile module can be removably attached to the modular OMT on site, i.e. after deployment/installation of the modular OMT. The removability of the turnstile module (either on production or on site) enables the turnstile module to be manufactured/treated independently of the rest of the modular OMT. For example, the modular OMT can be modified in production: a broadband core modular OMT [e.g. without the turnstile module built in] is initially created/developed once, and the turnstile module is separately created/modified depending on a customer's needs to be removable attached to the modular OMT. The modular OMT can be also modified on site: if a customer wants to modify a polarization or a frequency sub-band of operation of an on-site OMT, the turnstile module need be the only component to be replaced. This thereby avoids a complete re-build/substitution of the entire OMT.

In some examples, a turnstile joint mounted from the rear can be provided, but it can also be mounted from the front, which may simplify its replacement.

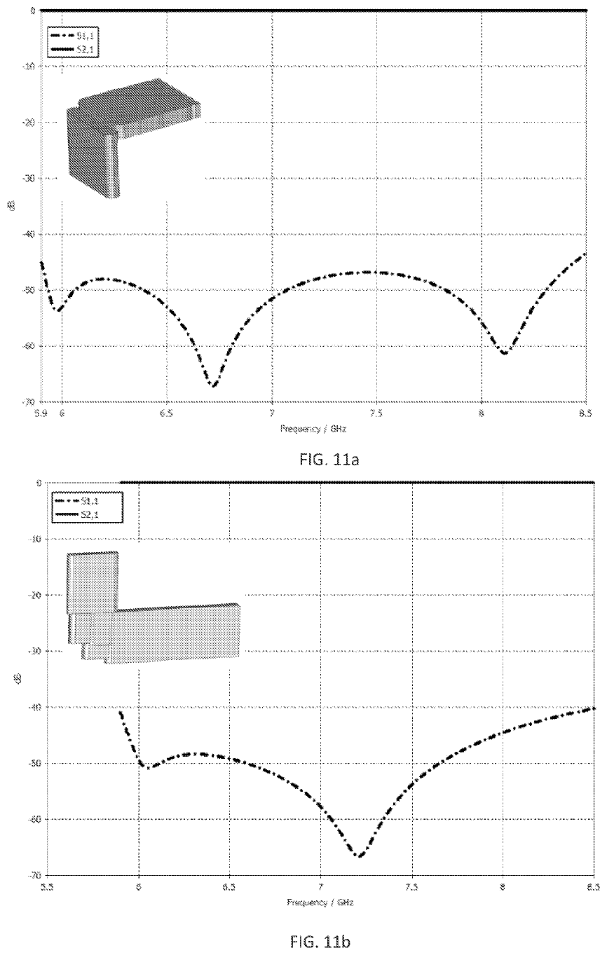

FIG. 10 shows simulation results of the return loss of two orthogonal polarizations in the turnstile junction of FIG. 8.

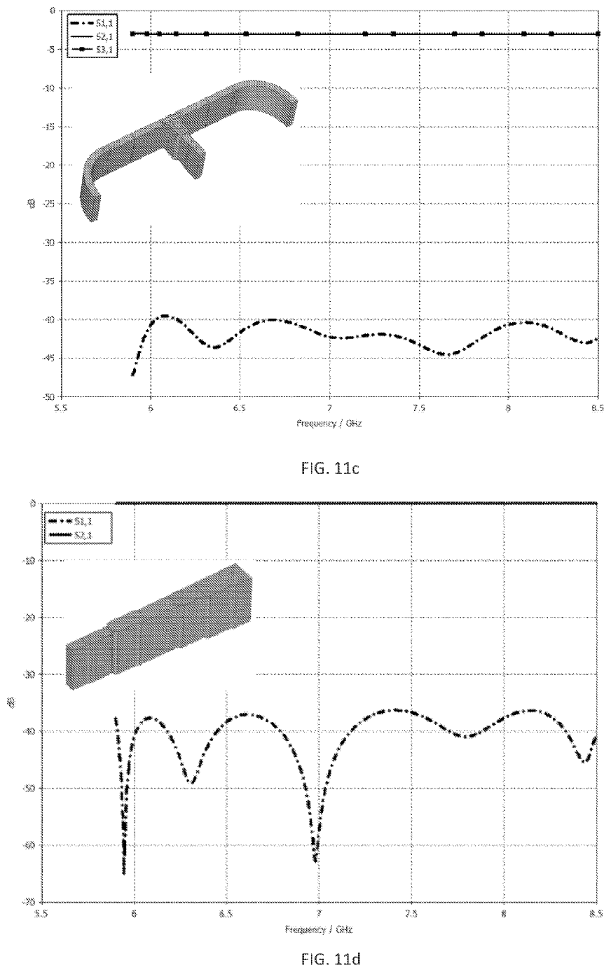

FIGS. 11a-11g show simulation results of the return loss of various components/waveguide elements in each of the radio paths of the OMT of FIG. 9.

The OMT components of FIG. 11(a-e) are used for polarization #1 and components of FIG. 11(f-g) for polarization #2. Each component can be optimised on its own to achieve the best possible RL on a desired band.

Various of the components can be defined by multiple rectangular, squared-rounded bricks or spline-shaped bricks defined by multiple parameters (e.g., length, width, bend radius, height, etc. . . . ). The optimization of a component can be carried out by an appropriate algorithm such as may be implemented via RF software. This may generate thousands of virtual component models having differing dimensions and evaluate their RF performance accordingly to input specifications (e.g. frequency bands intended to be used). The parameters/dimensions of the model having the best/optimal RF performance are used for the real-world components. Unit elements may be assembled, and another optimization may be done during assembly. The overall structure/assembly may be optimized, taking into account adaptation, phase effect, . . . ) of each component and their interaction through global optimization to obtain the best RL performance.

The components can be assembled into sub-assemblies and re-optimised as blocks to ensure that the blocks recombine well with each other.

FIGS. 11a-11e, show a 3D view of the following components of the OMT and simulation results of performances of the same:
FIG. 11(a) right angle E-plane elbow. This component is provided directly after the turnstile junction. As with the turnstile junction, the component uses overlapping rectangular guide sections to achieve an RL of 44 dB a least over a 40% band.
FIG. 11(b) right angle H-plane elbow. This component is placed just after component 11(a). The direction of the machining plane for this component (90°) is such that it gives the component the possibility to have bending radii in the H-plane, thus improving the bandwidth. The component uses overlapping rectangular guide sections to achieve an RL of 40 dB a minimum over a 40% band. The polarization #1 radio paths in the OMT of FIG. 9 are continued by E-plane curved waveguides and E-plane T-junction which allows the signals to be recombined.
FIG. 11(c) E-plane curved waveguides and E-plane T-junction. The curves of this component have been selected to reduce the footprint of the OMT. The component uses overlapping rectangular guide sections to improve the performance of the E-plane T-junction. This results in an RL of 39 dB a least over a 40% band.
FIG. 11(d) Stepped impedance waveguide. This component is used to gradually change the cross-section of the waveguide. The steps are initially sized to approximate λ/4 length and then optimised to improve RL performance. The output waveguide cross-section increases greatly to approach the dimensions of the diplexer waveguide at the end of the channel. This element exhibits a 37 dB RL over the targeted frequency band.
FIG. 11(e) Spline-based right-angle E-plane elbow and H-plane right-angle elbow. This component is used to terminate the radio path of polarization #1. The use of a spline allows both control of the direction of wave propagation, but also the use of smoother waveguide shapes for wave transmission. The machining process for this component is also simplified as the tool only follows one line to make the radio channel. The design of the H-plane right angle elbow is similar to the element in FIG. 11(b). The assembly has an RL of 42 dB at least over the whole band.
FIG. 11(f) Spline-based right-angle elbow. This component has a similar design to the spline in FIG. 11(e). Rather than using a circle section, the optimised spline best fits the behaviour of the wave to achieve a right-angle. It provides a 56 dB RL over a 40% band, which is a performance unmatched in the state of the art. This component can almost be considered as lossless from a radio point of view.
FIG. 11(g) E-plane T-junction with stepped impedance waveguides. As for the polarization #1, this T-junction component is quite similar to FIG. 11(c) and it is used to recombine the signals. Then, a stepped impedance waveguide, is used to gradually change the cross-section of the waveguide. The steps are initially sized to approximate λ/4 length and then optimised to improve RL performance. The output waveguide cross-section increases greatly to match the dimensions of the diplexer waveguide at the end of the channel. This element exhibits a 36 dB RL over the targeted frequency band.

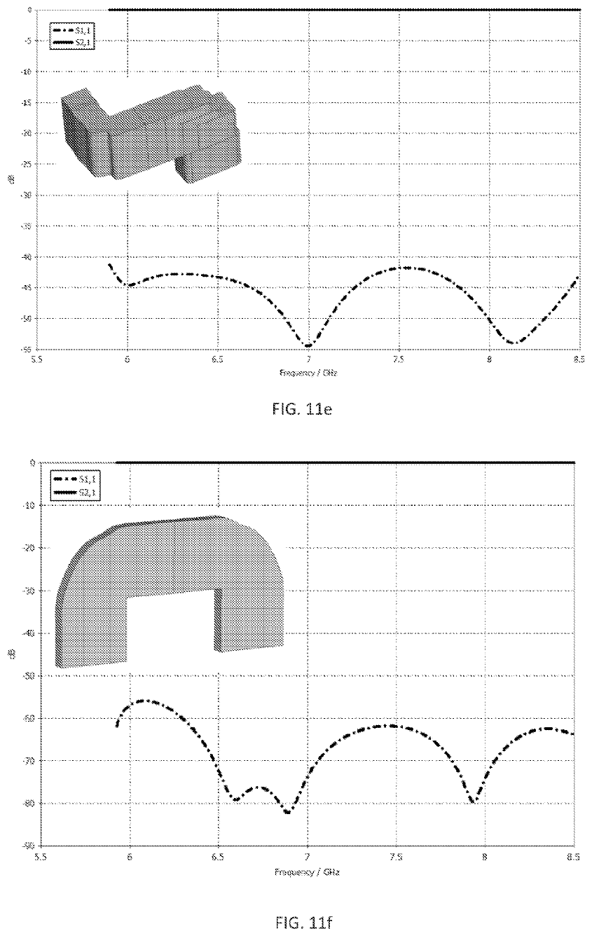

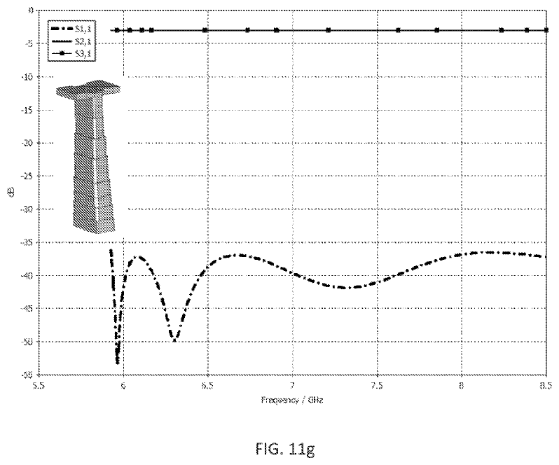

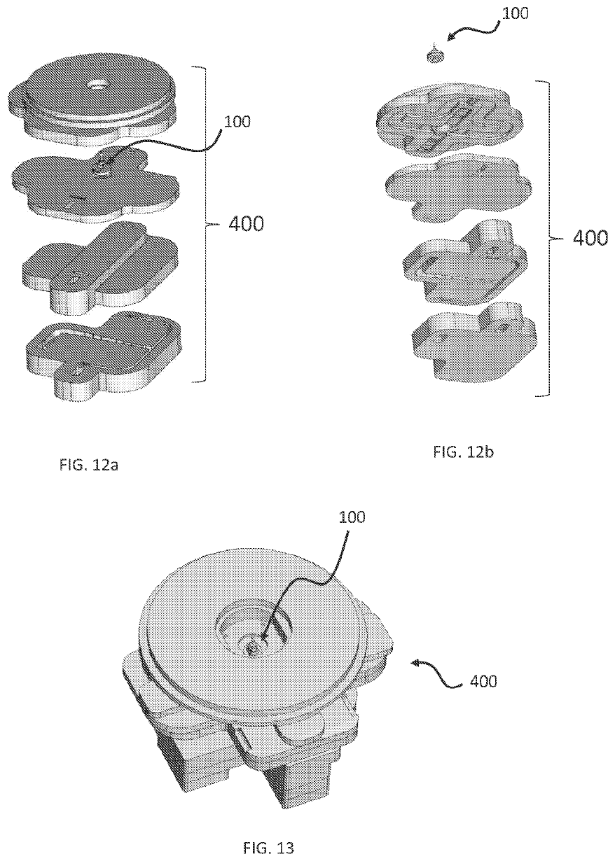

FIGS. 12a and 12b illustrate a top view and bottom view respectively of four machining layers for forming an OMT 400 such as the OMT of FIG. 9. These FIGs. also show a removable turnstile module 100 of a modular turnstile junction that is comprised/integrated in the OMT.

The simplicity and compactness of examples of the OMT according to the present invention allows the manufacturing by classical machining of the OMT system in four distinct layers, plus the separate manufacturing of the removable turnstile, before assembling them together.

FIG. 13 illustrates an OMT 400 (for example the layers of FIGS. 12a and 12b in an assembled form) with a removable turnstile module substantially at its centre.

As will be shown below, the OMT can achieve high RF performance over a 40% bandwidth, with a minimum Return Loss (RL) of 30 dB. The 40% bandwidth requirement with an RL of 30 dB is achieved by means of optimized components/unitary components of the OMT, namely: elbows, stepped impedance paths and a spline shaped power divider. Each component is designed so as to obtain an excellent RL (between 37 dB and 50 dB) over the whole targeted frequency band. By using a rectangular guide with customised dimensions, the OMT allows coverage of two contiguous bands, the 5.925 GHz-7.125 GHz band and the 7.4 GHz-8.5 GHz band. The common port, i.e. the circular port 203, of the OMT avoids the need to use R70 and R84 waveguides separately and may enable carrier aggregation on a single waveguide, i.e. a circular waveguide supporting TE11 mode. In some examples, rather than having a circular port and circular waveguide supporting TE11 mode, a square port and square waveguide can be provided that support a TE10 mode and an orthogonally set TE01 mode.

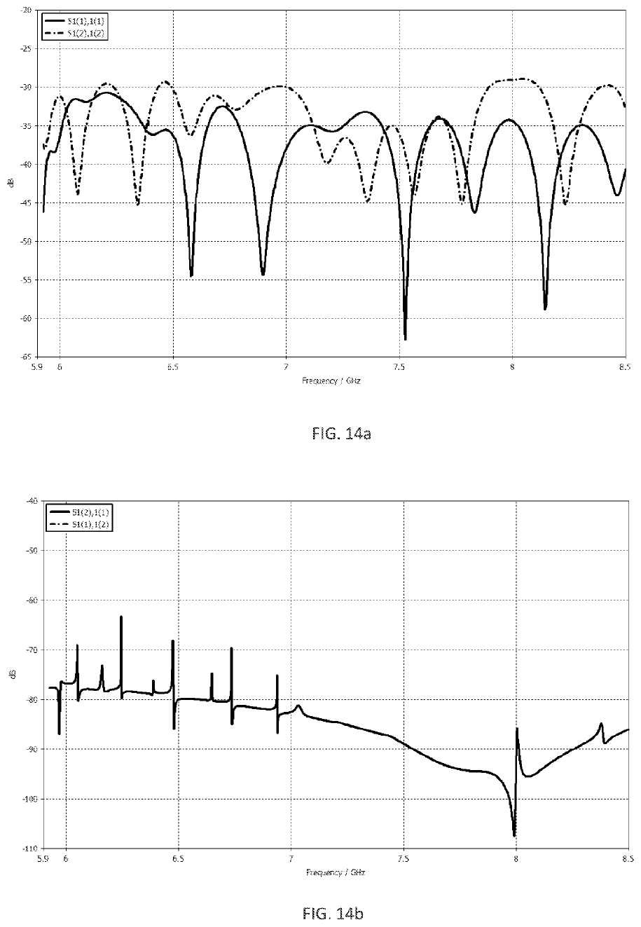

FIGS. 14a and 14b illustrate an example of the high RF performances of simulation results of the OMT of FIG. 13 with regards to return loss and isolation when operating in a microwave frequency band. FIG. 14a shows respectively simulation results of a return loss value lower than −31 dB on port 1, and −29 dB on port 2. FIG. 14b shows simulation results of an isolation value higher than 60 dB between the ports.

Due to the tuning capabilities of the OMT by virtue of the replaceable/interchangeable turnstile, the performance of the complete OMT can be modified without changing the radio channels and waveguides of the OMT, by simply modifying/optimising the detachable turnstile. A nominal configuration of the OMT may correspond to a balanced performance between working frequency sub-bands and polarisation. Different configurations may be required depending on a use specification, such as improving the RL of a particular band. This can be done by slightly reducing the performance of the rest of the operating band.

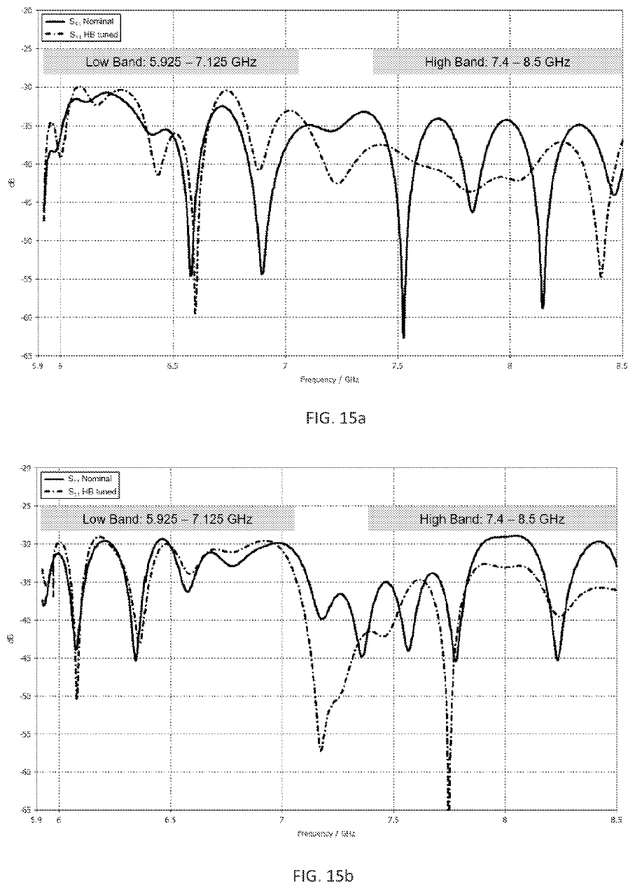

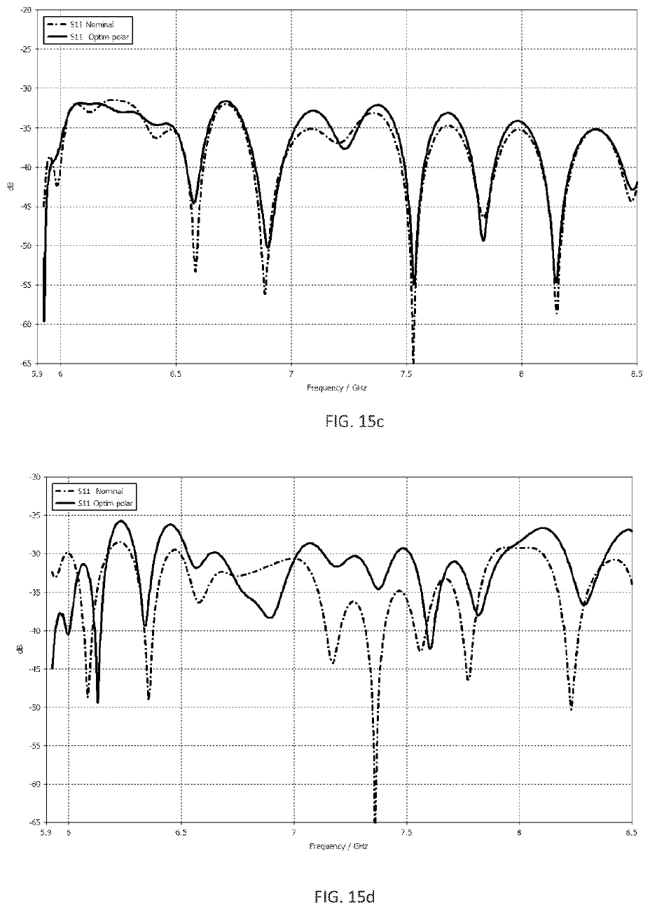

FIGS. 15a and 15b show an example of the return loss of the OMT of FIG. 9 for polarisation #1 and polarisation #2 respectively for each of a nominal configuration (solid line) and after optimization of a high band (dashed line). The only parameters changed are the dimensions of the removable turnstile (i.e. the dimensions and shapes of the metallic pins of the removable turnstile). The high band RL (dotted line) has been improved on both polarisations, from −33 dB to −37 dB max. for polarisation #1, and from −29 dB to −33 dB max. for polarisation #2. This corresponds to an improvement of about 4 dB. The low band has lost about 1 dB of RL for both polarisations.

FIGS. 15c and 15d show an example of the return loss of the OMT for the two polarizations, in nominal configuration (solid line) and after optimization of the polarization #1 (dashed line). The only parameters changed are the dimensions of the removable turnstile (i.e. the dimensions and shapes of the metallic pins of the removable turnstile). The RL has been improved from −31 dB to −32 dB max. for polarization #1 which corresponds to an improvement of about 1 dB. As a counterpart, the RL is degraded from −29 dB to −25.5 dB max. for polarization #2. This corresponds to a degradation of about 3.5 dB.

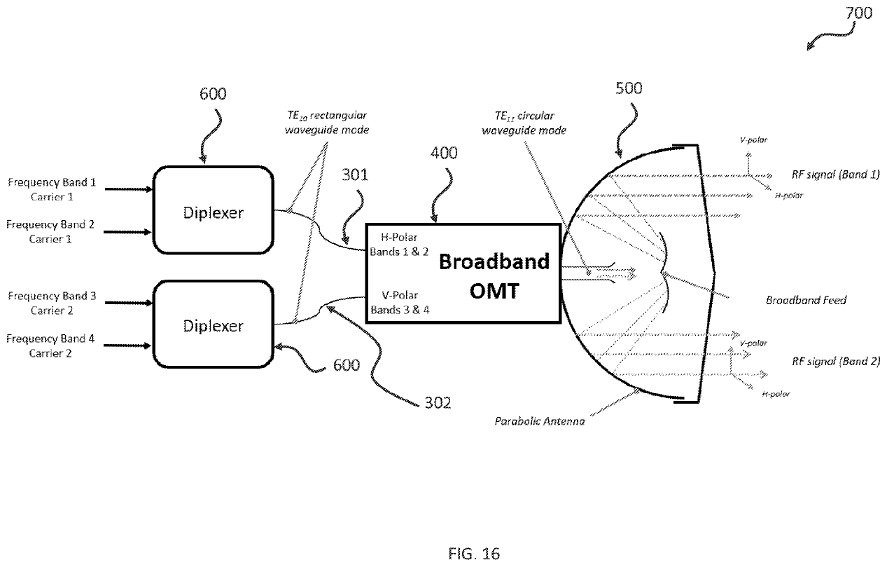

FIG. 16 shows an example of an antenna system 700 according to the present disclosure. In this example, the antenna system is a dual band, dual polarization antenna system that comprises: a broadband feed, two diplexers 600, a broadband OMT 400, and a dual polarization antenna 500.

The OMT supports 2×2 carriers over a unique radio path per polarisation. Thus, the OMT provides a dual-band and a dual-polarisation operation.

The two diplexers allow the use of two frequency bands, each diplexer corresponds to a polarization of the two bands. The antenna system enables the propagation of four RF signals, two in a low frequency band and two in a high frequency band, with two separate orthogonal polarizations.

When transmitting signals, the RF signals from the diplexers each propagate through a rectangular waveguide operating in fundamental mode, TE10, to the broadband OMT. The broadband OMT requires two orthogonal polarizations, namely vertical polarization (V-polar) and horizontal polarization (H-polar). The RF signals of the two frequency bands is transmitted through the broadband OMT. The broadband OMT's ports which are connected to the diplexers are rectangular operating in TE10, whereas the broadband OMT's backfire feed link operates in TE11 as a circular waveguide. Due to the intrinsic antenna system characteristics, the duality can be applied for receiving signals.

The aim of the broadband OMT is to aggregate the carriers from separated operating bands over a wide band of operation with the best possible transmission performance.

Examples of an OMT according to the present disclosure may provide the following benefits/advantages as compared to convention OMTs:
RF performances improved.
Extended bandwidth
Improved RL
Dual-carrier and dual-polarisation operation on a unique radio channel per polarisation
Spline-shaped radio components: power divider, elbow, radio paths
Removable turnstile junction enabling flexibility of development, ease of fabrication and tuning capability of the RF performances of the OMT

Examples of an OMT according to the present disclosure may provide at least the following advantages/improvements over conventional OMTs: 1) a very wide bandwidth, and 2) the possibility of modifying device performance by simply replacing just the removable turnstile module.

The very large bandwidth covered with a very low RL level allows the OMT to support dual-band and dual-polarisation configurations. Specific waveguide size may be used to support two sub-band of operation: i) 5.925 GHz-7.125 GHz and ii) 7.4 GHz-8.5 GHz. By the use of external diplexers, it is then possible to aggregate two carriers per radio path of the OMT.

The use of spline-based shapes provides flexibility in machining and allows a very high-performance RL to be achieved over a very wide bandwidth. In particular, the right-angle H-plane waveguide (see FIG. 11a) achieves a RL of less than −55 dB over 40% BW.

With regard to the removable turnstile module, by using a set of metallic pins with cylindrical or rounded square shapes, a stub effect is obtained which allows a smooth transition of the signals and a good discrimination of the polarisations in the turnstile junction. Examples of the disclosure provide flexibility in the design of the metallic pins, both in the choice of shapes and sizes and in the manufacturing technique. The metallic pins can be produced separately from the rest of the OMT, using different manufacturing processes or suppliers. This can lead to lower costs and can facilitate the respect of mechanical constraints on the OMT layer that supports the turnstile, notably on the management of flatness.

Examples of the present disclosure provide a removable turnstile module of a modular turnstile junction. The removable turnstile module is a high-precision part and it can be machined separately from the rest of the turnstile junction and OMT. This may enable an increase in RF reliability of the turnstile module. This also allows the performance of an entire OMT to be modified by simply changing the removable turnstile module, ensuring optimal RF performance without the risk of degradation or disruption of transmitted/received signals.

Since the OMT structure can be assembled/made up from a set of very low RL and very wide band unitary blocs, by modifying only the removable turnstile module, one can choose either:
to favour the RL of one polarisation over another (RL disymmetrisation)
to favour the RL on particular sub-bands

This can lead to a reduction in redesign and engineering as only the removable turnstile module would need to be modified (and not the whole of the rest of the turnstile junctions and OMT).

Examples of the present disclosure, and its OMTs with removable turnstile modules, may enable an optimization of use of available radio resources, e.g. by comminating of several channels on a single antenna. This may thereby reduce deployment costs and the environmental impact of the networks. Examples enable the use of dual polarized broadband antennas that can increase the capacity and quality of service (QoS) of a radio network, e.g. due to being able to use a large bandwidth. The use of such dual polarized broadband antennas may enable a reduction in costs for leasing towers onto which the antenna are mounted, a reduction in installation time as well as lightening the load on the tower structure.

Although specific terms are employed herein, they are used in a generic and descriptive sense only and not for purposes of limitation.

Features described in the preceding description can be used in combinations other than the combinations explicitly described.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’ and ‘couple’ and their derivatives mean operationally connected/coupled. It should be appreciated that any number or combination of intervening components can exist (including no intervening components), i.e. so as to provide direct or indirect connection/coupling.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example', 'for example', 'can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1. A tuning element module for a modular waveguide junction for combining and/or separating first and second signals of differing polarizations, wherein the tuning element module is configured to removably attach to said modular waveguide junction.

2. The tuning element module of claim 1, wherein the modular waveguide junction comprises one or more selected from the group of:
a turnstile junction;
an orthomode junction; and
a junction of an orthomode transducer.

3. The tuning element module of claim 1, wherein the tuning element module comprises a turnstile for use in a turnstile junction.

4. The tuning element module of claim 1, wherein the tuning element module comprises means for adjusting one or more of:
a radio frequency performance of said modular waveguide junction;
an operational bandwidth of said modular waveguide junction;
an operational frequency of said modular waveguide junction;
a return loss characteristic of said modular waveguide junction.

5. The tuning element module of claim 1, wherein the tuning element module comprises an elongate member extending from a base member.

6. The tuning element module of claim 5, wherein the elongate member comprises one or more of:
at least one tuning stub; and
at least one metallic pin.

7. The tuning element module of claim 5, wherein a cross-sectional shape of the elongate member varies along its length.

8. The tuning element module of claim 5, wherein the elongate member comprises one or more of:
at least one cylindrical portion, and
at least one rectangular portion.

9. The tuning element module of claim 5, wherein the elongate member comprises a rectangular portion with rounded edges.

10. The tuning element module of claim 5, wherein the elongate member comprises a cylindrical portion with a plurality of protruding rounded edges projecting therefrom.

11. The tuning element module of claim 5, wherein a cross-sectional dimension of the elongate member varies along its length.

12. The tuning element module of claim 1, further comprising means for providing a radio frequency wave trap.

13. The tuning element module of claim 5, further comprising at least one notch around a perimeter of the base member.

14. The tuning element module of claim 1, further comprising means for facilitating insertion into said modular waveguide junction.

15. The tuning element module of claim 5, wherein the base member comprises a chamfered edge or a bevelled edge.

16. The tuning element module of claim 1, further comprising means for locating and/or aligning the tuning element module in said modular waveguide junction.

17. The tuning element module of claim 5, wherein the base member comprises at least one projecting boss member.

18. A modular waveguide junction for combining and/or separating first and second signals of differing polarization, wherein the modular waveguide junction is configured to receive a removable tuning element module.

19. The modular waveguide junction of claim 18, further comprising the removable tuning element module.

20. An orthomode transducer comprising the modular waveguide junction of claim 18.

21. An antenna system comprising:
the orthomode transducer of claim 20; and
an antenna configured to transmit and/or receive a combination of the first and second signals.

22. The antenna system of claim 21 further comprising at least one diplexer.
